(19) United States
(12) Patent Application Publication
(10) Pub. No.: US 2012/0176270 A1
(43) Pub. Date: Jul. 12, 2012

(54) METHOD FOR PROVIDING RELIABILITY OF RECKONING LOCATION AND MOBILE TERMINAL THEREFOR

(75) Inventor: Gye Joong SHIN, Gyeonggi-do (KR)

(73) Assignee: SAMSUNG ELECTRONICS CO., LTD., Gyeonggi-Do (KR)

(21) Appl. No.: 13/083,660

(22) Filed: Apr. 11, 2011

(30) Foreign Application Priority Data
Jan. 10, 2011 (KR) 10-2011-0002182

(51) Int. Cl. G01S 19/45

(52) U.S. Cl. 342/357.28

(57) ABSTRACT

Disclosed are method and apparatus for evaluating reliability of reckoning location information and providing reliability information. A mobile terminal implementing the method provides a user with a handheld device to provide accurate location information. The method for providing reliability of a reckoning location preferably includes: reckoning a location using speed and direction information input from a sensor unit when satellite signal intensity of GPS satellite information is less than a first threshold value; calculating a moving distance using the reckoning location for a reckoned time of the location; evaluating the reliability of the reckoning location according to the moving distance; and providing the reckoning location and the reliability to a location information utility unit such that the location information utility unit determines presence of utility of the reckoning location according to the reliability.

### CLAIM OF PRIORITY

This application claims the benefit of priority under 35 U.S.C. §119 from Korean Patent Application No. 10-2011-0002182 filed Jan. 10, 2011, the contents of which are incorporated by reference in its entirety.

### BACKGROUND OF THE INVENTION

1. Field of the Invention

The present invention relates to systems that provide positioning and navigation, including the Positioning, Navigation, Car/Vehicle Navigation System (CNS) & Dead Reckoning ((DR); positioning navigation technology using inertial sensor)), Pedestrian Navigation System (PNS) & Pedestrian Dead Reckoning(PDR), Geo-Tagging, and Location Based Service (LBS). More particularly, the present invention relates to a method of evaluating reliability with respect to location information reckoned in a positioning shade zone to provide reliability information of reckoning location information, and an apparatus for implementing the same.

2. Description of the Related Art

Typical Global Positioning System (GPS) satellites continuously broadcast a navigation message at speed of 50 bps. In this case, the navigation message contains a Pseudo-Random Noise (PRN) comprising a unique code given every satellite, Elevation & Azimuth of satellite, state information of the satellite, time and error of clock mounted in the satellite, orbit information and almanac, ephemeris, and coefficient for compensating error.

A GPS receiver typically receives a signal provided from at least three GPS satellites to determine respective locations of a satellite and a receiver. The GPS receiver may measures a time difference between a signal provided from the satellite and a signal provided from the receiver to calculate a distance between the satellite and the receiver. The GPS receiver may calculate a location of the receiver using a trilateration based on distances between at least three satellites and locations of respective satellites. An atomic clock or a crystal oscillator is preferably mounted in the GPS receiver in order to provide necessary precision to accurately determine position. Since the watch of the GPS receiver may not keep proper time, a location is determined using at least four satellites to compensate for an error. The GPS receiver measures intensity of a satellite signal. Here, the intensity of a signal may be an absolute value of the signal itself but is preferably the Carrier-to-Noise-Ratio (CNR, C/N, or SNR) expressing a receiver performance of the GPS receiver.

A conventional positioning navigation technology reckons a location using information with speeds and directions provided from a sensor based on previous valid location information in various positioning methods such as GPS, a WiFi Positioning System (WPS), and/or a Cellular Network Positioning System (CPS) when a vehicle or a pedestrian moves a positioning shade zone such as tunnel, building, or forest in which an exact location may not be measured. Here, the sensor may include an inertial sensor and a secondary sensor. The inertial sensor includes an acceleration sensor and a gyro sensor. Further, the secondary sensor includes altimeter, barometer, compass, and magnetometer.

FIG. 1 is a block diagram illustrating a configuration of a mobile terminal implementing a conventional positioning navigation technology. Referring now to FIG. 1, a mobile terminal may include a GPS receiving unit 10, a sensor unit 20, a location calculating unit 30, and a location information utility unit 40.

The GPS receiving unit 10 provides GPS satellite information including a location of a GPS satellite, a transmitting time, a receiving time, and a satellite signal intensity to the location calculating unit 30. The sensor unit 20 provides altitude, speed, and direction information to the location calculating unit 30.

The location calculating unit 30 provides location information by calculating a location using GPS satellite information received from the GPS receiving unit 10, namely as second dimensional coordinates (such as latitude/longitude) output to the location information utility unit 40. Further, the location calculating unit 30 may provide altitude information, speed information, direction information, location error information, and GPS satellite information, as well as the location information, to the location information utility unit 40. Moreover, when GPS satellite information is not received by the GPS receiving unit 10 (or satellite information is not output from the GPS receiving unit), or the satellite signal intensity of input GPS satellite information is less than a threshold value and is considered to be invalid, the location calculating unit 30 reckons a location using information input from the sensor unit 20 and provides the reckoning location information to the location information utility unit 40 based on the information from the sensor unit 20.

The location information utility unit 40 may be in communication with a number of various application programs requiring location information. For example, the various application programs may include an augmented reality program and a navigation program. Moreover, the location information utility unit 40, in particular, an application program such as a navigation considering that reliability of location information is very important determines validity of location information by referring GPS satellite information. That is, such application programs determine that location information, i.e., estimation location information, provided without the GPS satellite information is unreliable, and therefore does not to use the location information deemed to be unreliable. This rejection of certain location information due to unreliability deteriorates efficiency in a GPS based positioning navigation technology.

### SUMMARY OF THE INVENTION

The present invention provides a method and apparatus for evaluating the reliability of reckoning location information and providing reliable information. In an exemplary embodiment of the present invention a mobile terminal implements the reliability evaluation.

In accordance with an exemplary aspect of the present invention, a method of providing reliability of a reckoning location preferably includes: reckoning a location using speed and direction information input from a sensor unit when the satellite signal intensity of GPS satellite information is less than a first threshold value; calculating a moving distance using the reckoning location for a reckoned time of the location; evaluating the reliability of the reckoning location according to the moving distance; and providing the reckoning location and the reliability to a location information utility unit such that the location information utility unit determines a presence of utility of the reckoning location according to the evaluated reliability.

Evaluating the reliability of the reckoning location preferably includes: a first reduction step of reducing a satellite signal intensity of the GPS satellite information stored in a storage unit when the moving distance is equal to or greater than a second threshold value; and a step of updating the reduced satellite signal intensity in the storage unit, wherein the reliability comprises the satellite signal intensity of the GPS satellite information stored in a storage unit. Evaluating the reliability of the reckoning location further includes: a second reduction step of reducing the satellite signal intensity of the GPS satellite information stored in a storage unit when the reckoned time of the location is equal to or greater than a third threshold value; and a step of updating the satellite signal intensity reduced at the second reduction step in the storage unit. The second and third threshold values are set differently (i.e. set to different values that may not be equal to each other) according to speed information inputted from the sensor unit.

In accordance with an exemplary aspect of the present invention, a method of providing reliability of a reckoning location further includes: calculating speed using GPS satellite information inputted from the GPS receiving unit, wherein the second and third threshold values are set differently according to the calculated speed. Calculating a moving distance preferably calculates the moving distance with the reckoning location using map information stored in the storage unit or altitude information inputted from the sensor unit.

In accordance with another exemplary aspect of the present invention, a method of providing reliability of a reckoning location includes: reckoning a location using speed and direction information input from a sensor unit when satellite signal intensity of GPS satellite information is less than a first threshold value; calculating a displacement for a reckoned time of the location; evaluating the reliability of the reckoning location according to the displacement; and providing the reckoning location and the reliability to a location information utility unit such that the location information utility unit determines presence of utility of the reckoning location according to the reliability.

Evaluating the reliability of the reckoning location preferably includes: comparing the displacement with a fourth threshold value and controlling a satellite signal intensity of GPS satellite information stored a storage unit; and updating the controlled satellite signal intensity in the storage unit, wherein the reliability comprises the satellite signal intensity of the GPS satellite information stored in a storage unit.

Controlling a satellite signal intensity of GPS satellite information includes: reducing the satellite signal intensity of the GPS satellite information stored in a storage unit when the displacement is greater than the fourth threshold value; and increasing the satellite signal intensity when the displacement is less than the fourth threshold value to update the increase satellite signal intensity in the storage unit. The fourth threshold value is set differently according to speed information input from the sensor unit.

In accordance with an exemplary aspect of the present invention, a method of providing reliability of a reckoning location further includes: calculating speed using GPS satellite information input from the GPS receiving unit, wherein the fourth threshold value is set differently according to the calculated speed.

In accordance with another exemplary aspect of the present invention, a mobile terminal includes: a GPS receiving unit; a sensor unit measuring speed and a direction; a location calculating unit for reckoning a location using speed and direction information of the sensor unit when satellite signal intensity of GPS satellite information received from the GPS receiving unit is less than a first threshold value; a reliability evaluator for evaluating reliability of the location reckoned by the location calculating unit; and an information providing unit providing the reckoning location and the reliability to a location information utility unit such that the location information utility unit determines presence of utility (i.e. whether or not to utilize) of the reckoning location according to the reliability.

The location calculating unit preferably stores GPS satellite information input from the GPS receiving unit in a storage unit, and the reliability evaluator includes: a moving distance calculator calculating a moving distance using the reckoning location input from the location calculator; and a signal intensity controller reducing satellite signal intensity of the GPS satellite information stored in the storage unit when the moving distance is equal to or greater than a second threshold value, and updating the reduced satellite signal intensity in the storage unit, wherein the reliability includes the satellite signal intensity stored in the storage unit.

The signal intensity controller preferably reduces the satellite signal intensity of the GPS satellite information stored in the storage unit when the reckoned time of a location is equal to or greater than a third threshold value. The second and third threshold values preferably are set differently according to speed information input from the sensor unit. The location calculator calculates speed using GPS satellite information input from the GPS receiving unit, and the second and third threshold values are set differently according to the calculated speed. The moving distance calculator calculates a moving distance calculates the moving distance with the reckoning location using map information stored in the storage unit or altitude information input from the sensor unit. The location calculator stores the GPS satellite information input from the GPS receiving unit, and the reliability evaluator includes: a displacement calculator calculating a displacement for the reckoned timed of a location; and a signal intensity controller comparing the displacement with a fourth threshold value to control satellite signal intensity of the GPS satellite information stored in the storage unit, and updating the controlled satellite signal intensity in the storage unit, wherein the reliability includes the satellite signal intensity stored in the storage unit.

As illustrated above, a method and a mobile terminal implementing the same according to exemplary aspects of the present invention provides reliability for reckoning location information to increase efficiency of GPS satellite based positioning navigation technology. In addition, the present invention may increase utility of all types of application programs requiring location information.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating a configuration of a mobile terminal implementing a conventional positioning navigation technology;

FIG. 2 and FIG. 3 are block diagrams illustrating a configuration of a mobile terminal according to an exemplary embodiment of the present invention;

FIG. 4A and FIG. 4B are flowcharts illustrating a method providing reliability of a reckoning location according to an exemplary embodiment of the present invention; and

FIG. 5A and FIG. 5B are flowcharts illustrating a method providing reliability of a reckoning location according to another exemplary embodiment of the present invention.

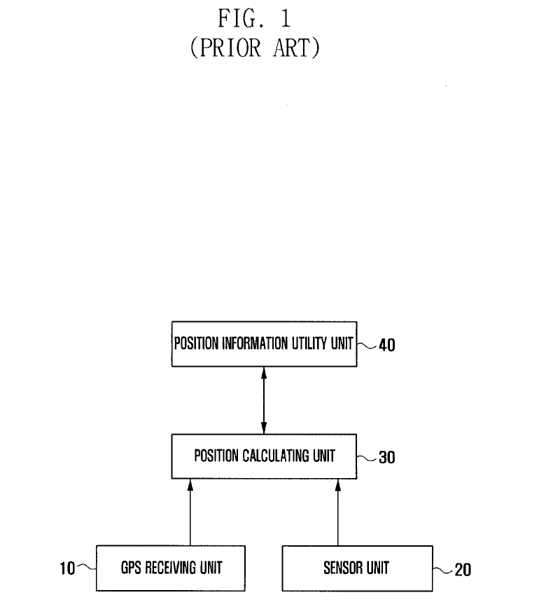

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring appreciation of the subject matter of the present invention by a person of ordinary skill in the art.

Hereinafter, a method providing reliability of a reckoning location and a mobile terminal implementing the same according to an exemplary embodiment of the present invention will be described in detail with reference to the accompanying drawings.

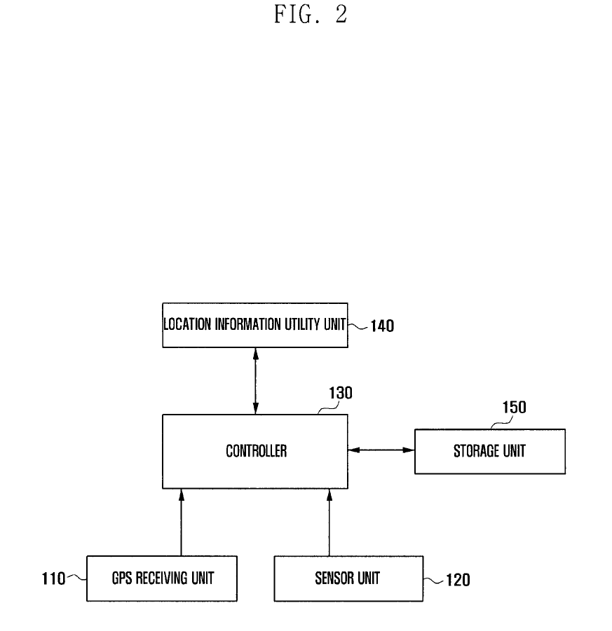

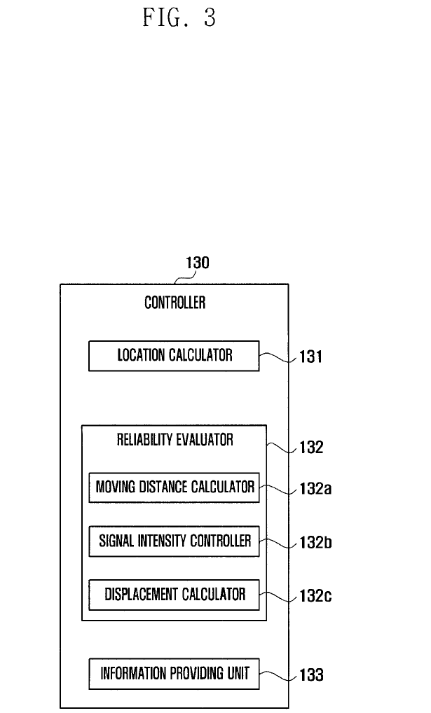

FIG. 2 and FIG. 3 are block diagrams illustrating a configuration of a mobile terminal according to an embodiment of the present invention.

Referring now to FIG. 2, a mobile terminal of the present invention preferably includes a GPS receiving unit 110, a sensor unit 120, a controller 130, a location information utility unit 140, and a storage unit 150. The sensor unit 120 measures and provides speed and a direction to the controller 130. The storage unit 150 stores location information, GPS satellite information, and map information.

Here, the controller 130 preferably controls all structural elements of the mobile terminal.

Referring now to FIG. 3, the controller 130 preferably includes a location calculator 131, a reliability evaluator 132, and an information providing unit 133. The reliability evaluator 132 evaluates the reliability of reckoning location provided from the location calculator 131. The information providing unit 133 provides location information and reliability information stored in the storage unit 150 to the location information utility unit 140.

As shown in FIG. 3, the reliability evaluator 132 preferably includes a moving distance calculator 132a, a signal intensity controller 132b, and a displacement calculator 132c. The moving distance calculator 132a preferably calculates a moving distance using a reckoning location input from the location calculator 131 for a reckoned time of a location. The signal intensity controller 132b preferably adjusts and updates satellite signal intensity of GPS satellite information stored in the storage unit 150 based on the reckoned time of a location, a moving distance for the reckoned time of a location and a displacement for the reckoned time of a location. The displacement calculator 132c calculates a displacement for the reckoned time of a location.

In more detail, the position calculator 131 preferably compares satellite signal intensity of GPS satellite information input from the GPS receiving unit 110 with a first threshold value to determine a validity of the GPS satellite information.

When the GPS satellite information received by the GPS receiving unit 110 that is input to the controller 130 or the satellite signal intensity of the GPS satellite information is greater than the first threshold value and valid, the position calculator 131 calculates a location, speed, a direction, and a moving distance using the GPS satellite information from the GPS receiving unit 110, and updates them and location error information in the storage unit 150, and provides them and location error information to the location information utility unit 140. Further, the location calculator 131 may update the GPS satellite information input from the GPS receiving unit 110 in the storage unit 150, and provide the input GPS satellite information to the position information utility unit 140.

When the GPS satellite information received by the GPS receiving unit 110 that is not input to the controller 130 or satellite signal intensity of the input GPS satellite information is less than the first threshold value and deemed to be invalid (namely, the mobile terminal is located in a positioning shade zone), the position calculator 131 reckons a location using information input from the sensor unit 120 and updates the reckoned location in the storage unit 150, and provides it to the location information utility unit 140. Further, the location calculator 131 may update information, namely, speed, altitude, and direction information input from the sensor unit 120 in the storage unit 150, and provide them to the position information utility unit 140. Here, no information means a case where the GPS receiving unit 110 does not receive a signal from at least three satellites.

With continued reference to FIG. 3, the moving distance calculator 132a may calculate with near-exactness a moving distance for the reckoned time of a location using altitude information of the sensor unit 120 or map information stored in the storage unit 150 as well as reckoning location information.

When a moving distance input from the moving distance calculator 132a is greater than a second threshold value “Xn”, the signal intensity controller 132b reduces satellite signal intensity stored in the storage unit 150 and updates the reduced satellite signal intensity in the storage unit 150. However, when the satellite signal intensity stored in the storage unit 150 is greater than a set minimum value “Min”, the signal intensity controller 132b reduces the satellite signal intensity. The signal intensity controller 132b controls the second threshold value from Xn to Xn+1(Xn+1>Xn). When the GPS satellite information is input from the GPS receiving unit 110 or the input GPS satellite information is determined to be valid, the signal intensity controller 132b preferably initializes the second threshold value (Xn−>X0; Xn>X0).

When the reckoned time of a location is greater than a third threshold value “Yn”, the signal intensity controller 132b reduces the satellite signal intensity stored in the storage unit 150 and updates the reduced satellite signal intensity in the storage unit 150. However, as illustrated earlier, when the satellite signal intensity stored in the storage unit 150 is greater than a minimum value “Min”, the signal intensity controller 132b reduces the satellite signal intensity. Furthermore, the signal intensity controller 132b controls the third threshold value from Yn to Yn+1(Yn+1>Yn). In addition, when the GPS satellite information is input from the GPS receiving unit 110 or the input GPS satellite information is valid, the signal intensity controller 132b initializes the third threshold value (Yn−>Y0; Yn>Y0).

When a displacement input from the displacement calculator 132c is greater than a fourth threshold value “Zn”, the signal intensity controller 132b reduces satellite signal intensity stored in the storage unit 150 and updates the reduced satellite signal intensity in the storage unit 150. However, as discussed herein above, when the satellite signal intensity stored in the storage unit 150 is greater than the minimum value Min, the signal intensity controller 132b reduces the satellite signal intensity. The signal intensity controller 132b controls the fourth threshold value from Zn to Zn+1(Zn+1>Zn). When the GPS satellite information is input from the GPS receiving unit 110 or the input GPS satellite information is valid, the signal intensity controller 132b initializes the fourth threshold value (Zn−>Z0; Zn>Z0). On the other hand, when the displacement is less than a previous value (Zn−1; Zn−1<Zn), the signal intensity controller 132b increases the satellite signal intensity stored in the storage unit 150 and updates the increased satellite signal intensity in the storage unit 150. Further, the signal intensity controller 132b restores the fourth threshold value from Zn to the previous value Zn−1.

Furthermore, the signal intensity controller 132b may differently set respective initial values X0, Y0, Z0 of second to fourth threshold values and control widths thereof (e.g., interval between Xn and Xn+1) according to speed and direction information input from the sensor unit 120 or the location calculator 131. For example, the signal intensity controller 132b divides a moving form (i.e. the mode of transportation) of a user into at least one of walking, stagnated vehicle traffic, delayed vehicle traffic, and easy vehicle traffic using input speed and direction information. When there is an amount of change of direction that is greater than a fifth threshold value and a speed is less than a sixth threshold value, the signal intensity controller 132b determines that the moving form (mode of transportation) of a user is walking and sets X0 to ‘10’ and sets a control widths of the fifth and sixth threshold values to ‘5’. When a change amount of direction is less than a fifth threshold value and speed is less than a seventh threshold value, the signal intensity controller 132b determines that the moving form of a user is the stagnated vehicle traffic and sets X0 to ‘10’ and sets control widths of the fifth and seventh threshold values to ‘10’. Meanwhile, when the speed is greater than the seventh threshold value, the signal intensity controller 132b determines that the moving form of a user is the delayed vehicle traffic, and sets X0 to ‘20’ and sets a control width of the seventh threshold value to ‘15’. When speed is greater than the eighth threshold value, the signal intensity controller 132b determines that the moving form of a user is the easy vehicle traffic, and sets X0 to ‘30’ and sets a control width of the easy vehicle traffic to ‘20’. Further, the control width of the threshold value may be gradually increased or reduced. For example, a control width of a threshold value may be increased in an interval of substantially “10−>20−>30” or reduced in an interval of “30−>20−>10”. The control width may be an equal interval.

The location information utility unit 140 receives the location information and GPS satellite information stored in the storage unit 150 from the information providing unit 133. As illustrated previously, the location information may be a GPS location information or reckoning location information calculated using GPS satellite information. When satellite signal intensity of the received GPS satellite information is greater than a ninth threshold value, the location information utility unit 140 utilizes the received location information.

On the other hand, when satellite signal intensity of the received GPS satellite information is less than the ninth threshold value, the location information utility unit 140 does not utilize the received location information. In other words, although the location information is GPS location information, when the satellite signal intensity thereof is less than the ninth threshold value, the location information utility unit 140 may not utilize the GPS location information. However, although the location information is reckoning location information, when the satellite signal intensity thereof is greater than the ninth threshold value, the location information utility unit 140 may utilize the reckoning location information. Therefore, the reliability of the reckoning location information may be higher than that of the GPS location information. Here, the ninth threshold value may be the foregoing minimum Min or another value set in a corresponding application program.

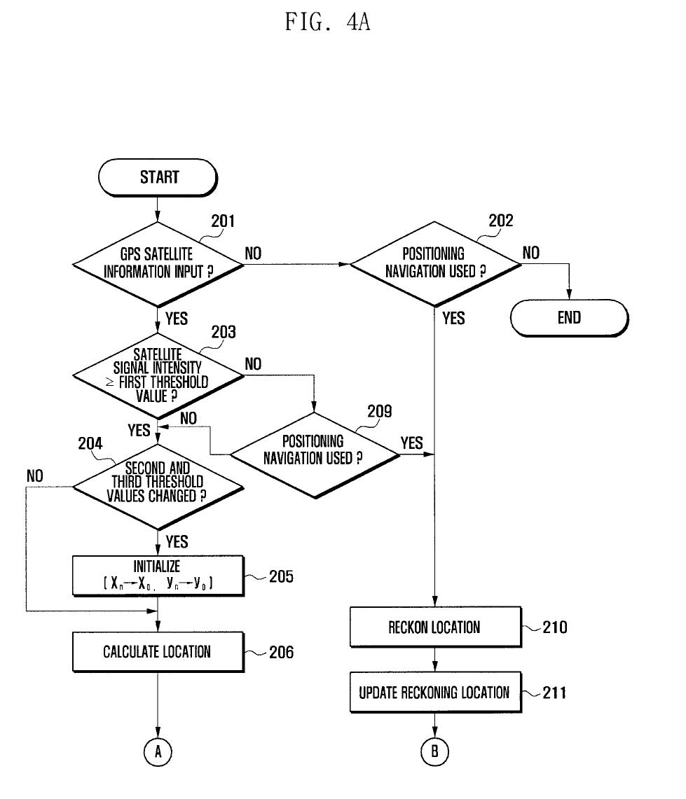

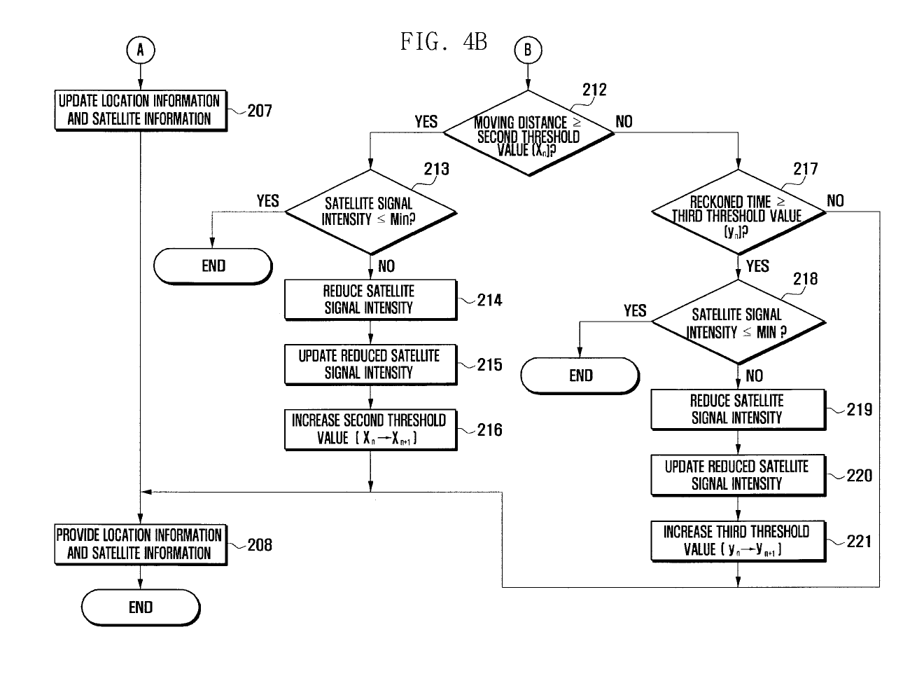

FIG. 4A and FIG. 4B are flowcharts illustrating exemplary operation of a method for providing reliability of a reckoning location according to an exemplary embodiment of the present invention, which are performed by the controller 130.

First, at (S201), a controller 130 checks whether GPS satellite information is input. As a result of the check, when the GPS satellite information is not inputted, at (S202) the controller 130 determines whether or not a positioning navigation is used based on a set value in a storage unit 150. Since the positioning navigation is generally set to be used as a default, the controller 130 then performs (S210). However, when reliability of the GPS satellite information stored in the storage unit 150 is evaluated to be unreliable based on, for example, being below a threshold value signal level, the controller 130 may not utilize the positioning navigation. A detailed description thereof will be given below.

When the controller 130 receives the GPS satellite information from a GPS receiving unit 110, at (S203) the controller compares satellite signal intensity of the GPS satellite information with a first threshold value, and determines whether the satellite signal intensity if greater than or equal to the first threshold value.

As the comparison result at (S203), when the satellite signal intensity of the GPS satellite information is less than the first threshold value, then at (S209) the controller 130 checks whether a positioning navigation is used based on a set value stored in a storage unit 150. As the checked result at (S209), when the positioning navigation is set to be used, the controller 130 performs (S210). On the other hand, when the positioning navigation is not set to be used, the controller 130 goes performs (S204). Here, presence of utility of the positioning navigation at step 209 may be set differently from that at (S202). For example, utility may be set at (S202), but non-utility may be set at (S209).

When performing a comparison at (S203), if the satellite signal intensity of the GPS satellite information is equal to or greater than the first threshold value, at (S204) the controller 130 checks whether or not a second threshold value and a third threshold value are changed. Here, at least three satellite signal intensities should be all equal to or greater than the first threshold value. As a checked result at (S204), when the second and third threshold values are not changed, namely, when both of the second and third threshold values have an initial value, the controller 130 then performs (S206). When at least one of the second and third threshold values does not have the initial value, then at (S205) the controller 130 initializes the second and third threshold values.

At (S206), the controller 130 calculates a location using the GPS satellite information input from the GPS receiving unit 110. Besides this, the controller 130 may calculate speed, a direction, and a moving distance. Next, with reference to FIG. 4B, at (S207) the controller 130 updates the location, the speed, and the GPS satellite information input from the GPS receiving unit 110 in the storage unit 150. Subsequently, at (S208) the controller 130 provides the location and the GPS satellite information updated in the storage unit 150 to the location information utility unit 140.

Meanwhile, with reference to FIG. 4A, at (S210) the controller 130 reckons a location using information such as speed and a direction input from a sensor unit 120. Next, at (S211) the controller 130 updates a reckoning location in the storage unit 150. Subsequently, at (S212) the controller 130 compares a moving distance for a reckoned time of a location with a second threshold value (FIG. 4B).

As a result of the comparison at (S212), when the moving distance is equal to or greater than the second threshold value, at (S213) the controller 130 compares satellite signal intensity stored in the storage unit 150 with a minimum value Min. Here, the minimum value means a limit of reliability of GPS satellite information stored in the storage unit 150.

As a result of the comparison at (S213), when the satellite signal intensity is greater than the minimum value, at (s214) the controller 130 reduces the satellite signal intensity. Next, at (S215) the controller 130 updates the reduced satellite signal intensity in the storage unit 150. The controller 130 at (S216) then increases the second threshold value from Xn to Xn+1) and then performs (S208). Here, when the second threshold value Xn is a set maximum value X_Max, the controller 130 omits (S216) and goes to (S208). Because the second threshold value becomes a maximum value, reduction in the satellite signal intensity may be meaningless. Namely, X_Max may mean that reliability of GPS satellite information stored in the storage unit 150 becomes a limit like the minimum value Min. Accordingly, in a next cycle, steps 212 to 221 may be omitted and step 208 may be performed directly after step 211. Furthermore, the positioning navigation itself may not be used.

As a result of the comparison result at (S212), when the moving distance is less than the second threshold value, at (S217) the controller 130 compares a reckoned time of a location with a third threshold value. As a result of the comparison result at (S217), when the reckoned time of a location is less than the third threshold value, the controller 130 performs (S208). On the other hand, when the reckoned time of a location is equal to or greater than the third threshold value, at (S218) the controller 130 compares the satellite signal intensity stored in the storage unit 150 with the minimum value Min. As a result of the comparison at (S218), when the satellite signal intensity is greater than the minimum value, at (S219) the controller 130 reduces the satellite signal intensity. Next, at (S220), the controller 130 updates the reduced satellite signal intensity in the storage unit 150. Subsequently, the controller 130 increases the third threshold value from Yn to Yn+1 (221) and then performs (S208). Here, when the third threshold value Yn is a set maximum value Y_Max, the controller 130 omits step 221 and goes to (S208). Because the third threshold value becomes a maximum value, reduction in the satellite signal intensity may have no meaning. Accordingly, in a next cycle, steps 212 to 221 may be omitted and step 208 may be performed directly after step 211.

Furthermore, the positioning navigation itself may not be used. In other words, when the satellite signal intensity becomes a minimum value or the second threshold value or the third threshold value becomes a maximum value, the controller 130 determines that reliability of a reckoning location becomes a limit and may not perform the positioning navigation.

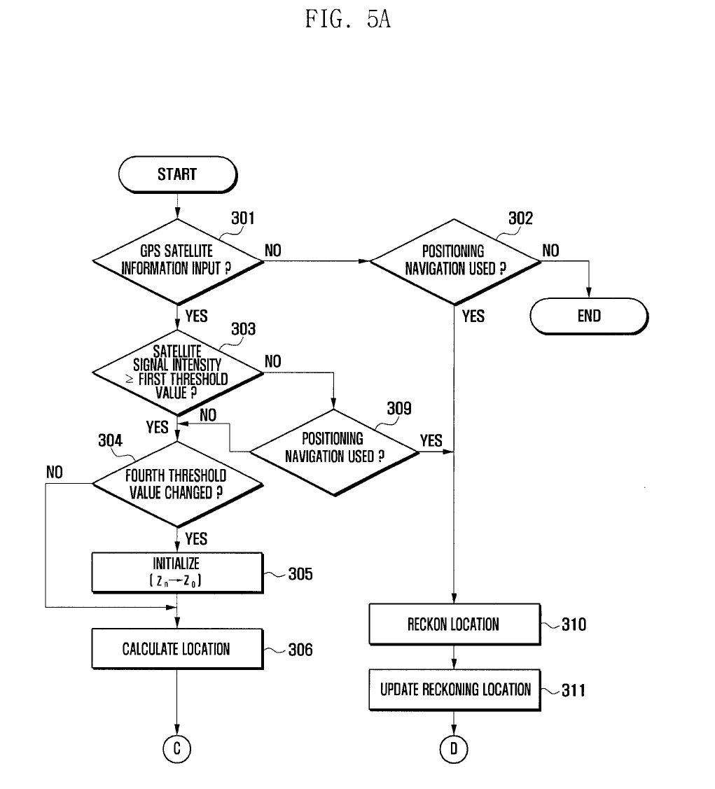

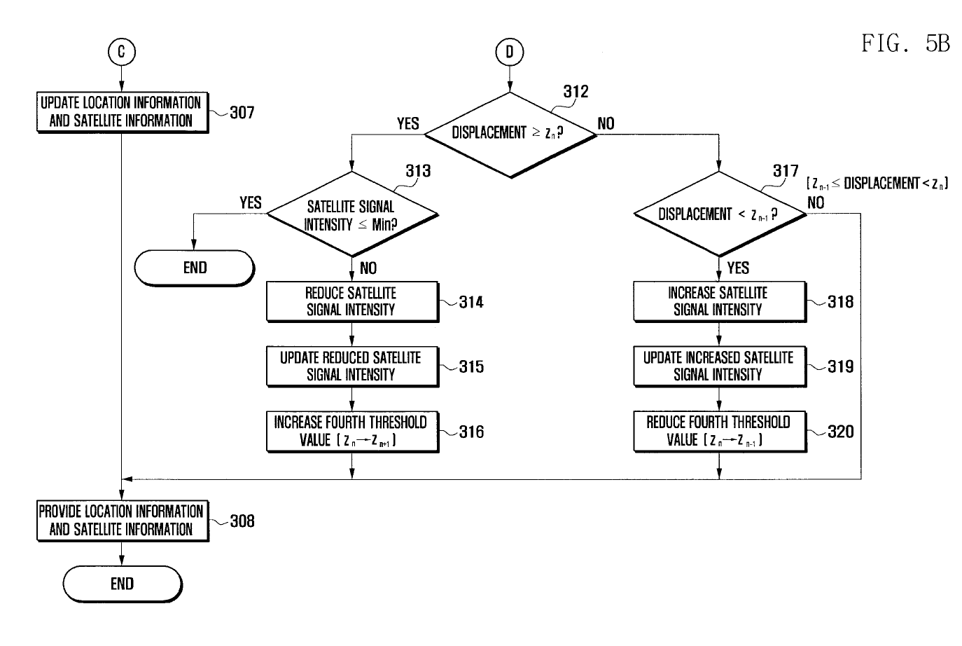

FIG. 5A and FIG. 5B are flowcharts illustrating a method providing reliability of a reckoning location according to another exemplary embodiment of the present invention, which is performed by a controller 130.

Steps 301 to 311 shown in FIG. 5A and FIG. 5B are identical to steps 201 to 211 shown in FIG. 4A and FIG. 4B, and thus the description thereof is omitted. One difference between FIG. 4A and FIG. 4B is that step 304 checks whether a fourth threshold value Zn is changed. An additional difference is that step 305 initializes the fourth threshold value.

At (S312), the controller 130 compares a displacement for a reckoned time of a location with a fourth threshold value Zn. As a comparison result at step 312, when the displacement is equal to or greater than the fourth threshold value, at (S313) the controller 130 compares the satellite signal intensity stored in the storage unit 150 with the minimum value Min. As a result of the comparison at (S313), when the satellite signal intensity is greater than the minimum value Min, at (S314) the controller 130 reduces the satellite signal intensity. Next, at (S315) the controller 130 updates the reduced satellite signal intensity in the storage unit 150. Subsequently, at (S316) the controller 130 increases the fourth threshold value from Zn to Zn+1, and then performs (S308). When the fourth threshold value Zn is a set as a maximum value Z_Max, the controller 130 omits step 316 and goes to step 308. Namely, X_Max may mean that reliability of GPS satellite information stored in the storage unit 150 becomes a limit like the minimum value Min. Accordingly, in a next cycle, steps 312 to 320 may be omitted and step 308 may be performed directly after step 311. Furthermore, the positioning navigation itself may not be used. However, when the displacement is again less than the set maximum value Z_Max (e.g., displacement is reduced when a user return to a first shade zone), steps 312 to 330 may be again performed.

As a result comparison result at step 312, when the displacement is less than the fourth threshold value Zn, the controller 130 compares the displacement with a previous value Zn−1. As a result of the comparison at step 317, when the displacement is greater than the previous value Zn−1, the controller 130 performs step 308. On the other hand, when the displacement is less than the previous value Zn−1, at (S318) the controller 130 increases the satellite signal intensity stored in the storage unit 150. Next, at (S319) the controller 130 updates the increased satellite signal intensity in the storage unit 150. Subsequently, at (S320) the controller 130 reduces the fourth threshold value from Zn to Zn−1 and then performs step 308.

Although a method providing reliability of a reckoning location and a mobile terminal implementing the same according to exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

The above-described methods according to the present invention can be realized in hardware or as software or computer code that can be stored in a non-transitory recording medium such as a CD ROM, an RAM, a floppy disk, a hard disk, or a magneto-optical disk or downloaded over a network, so that the methods described herein can be rendered in such software using a general purpose computer, microprocessor or a special processor or in programmable or dedicated hardware, such as an ASIC or FPGA. As would be understood in the art, the computer, the processor, microprocessor (controller) or the programmable hardware include memory components, e.g., RAM, ROM, Flash, etc. that may store or receive software or computer code that when accessed and executed by the computer, processor or hardware implement the processing methods described herein.

What is claimed is:

1. A method for providing reliability of a reckoning location, the method comprising:
reckoning by a controller a location using speed and direction information input from a sensor unit when a satellite signal intensity of Global Positioning System (GPS) satellite information received by a GPS receiving unit is less than a first threshold value;
calculating by the controller a moving distance using the reckoning location for a time of the reckoning location;
evaluating by the controller a reliability of the reckoning location according to the moving distance; and
providing by the controller the reckoning location and the reliability to a location information utility unit, and determining by the location information utility unit whether to utilize the reckoning location according to the evaluated reliability.

2. The method of claim 1, wherein evaluating the reliability of the reckoning location comprises:
a first reduction step of reducing a satellite signal intensity of the GPS satellite information stored in a storage unit when the moving distance is equal to or greater than a second threshold value; and
updating the reduced satellite signal intensity in the storage unit,
wherein the evaluated reliability comprises the updated reduced satellite signal intensity of the GPS satellite information stored in a storage unit.

3. The method of claim 2, wherein evaluating the reliability of the reckoning location further comprises:
a second reduction step of reducing the satellite signal intensity of the GPS satellite information stored in the storage unit when the time of the reckoning location is equal to or greater than a third threshold value; and
a step of updating the satellite signal intensity reduced at the second reduction step in the storage unit.

4. The method of claim 3, wherein the second and third threshold values are set to different values according to speed information inputted from the sensor unit.

5. The method of claim 3, further comprising calculating by the controller speed using GPS satellite information inputted from the GPS receiving unit, wherein the second and third threshold values are set to different values according to the calculated speed.

6. The method of claim 3, wherein calculating a moving distance by the controller comprises calculating the moving distance with the reckoning location using map information stored in the storage unit or altitude information inputted from the sensor unit.

7. A method for providing reliability of a reckoning location, the method comprising:
reckoning a location by a controller using speed and direction information input from a sensor unit when satellite signal intensity of Global Positioning System (GPS) satellite information received by a GPS receiving unit is less than a first threshold value;
calculating a displacement for a time of the reckoning location;
evaluating by the controller a reliability of the reckoning location according to the calculated displacement; and
providing the reckoning location and the reliability to a location information utility unit, and determining by the location information utility unit whether to utilize the reckoning location according to the evaluated reliability.

8. The method of claim 7, wherein evaluating the reliability of the reckoning location comprises:
comparing the calculated displacement with a threshold value for displacement and controlling a satellite signal intensity of GPS satellite information stored a storage unit; and
updating a value of the controlled satellite signal intensity that is stored in the storage unit,
wherein the evaluated reliability comprises the satellite signal intensity of the GPS satellite information stored in the storage unit.

9. The method of claim 8, wherein controlling a satellite signal intensity of GPS satellite information comprises:
reducing the value of the satellite signal intensity of the GPS satellite information stored in a storage unit when the displacement is greater than the threshold value for displacement; and
increasing the satellite signal intensity when the displacement is less than the threshold value for displacement to update the increase satellite signal intensity in the storage unit.

10. The method of claim 9, wherein the threshold value for displacement is set according to speed information input from the sensor unit.

11. The method of claim 9, further comprising calculating speed using GPS satellite information input from the GPS receiving unit, wherein the threshold value for displacement is set according to the calculated speed.

12. A mobile terminal comprising:
a Global Positioning System (GPS) receiving unit for receiving a GPS satellite signal;
a sensor unit measuring speed and a direction of a mobile terminal;
a location calculating unit for reckoning a location using the speed and direction information measured by the sensor unit when an intensity of the GPS satellite signal received from the GPS receiving unit is less than a first threshold value;
a reliability evaluator for evaluating reliability of the location reckoned by the location calculating unit; and
an information providing unit for providing the reckoning location and the reliability to a location information utility unit in which the location information utility unit determines whether or not to utilize the reckoning location according to the evaluated reliability of the location reckoned by the location calculating unit.

13. The mobile terminal of claim 12, wherein the location calculating unit stores in a storage unit the GPS satellite information output by the GPS receiving unit, and the reliability evaluator comprises:
a moving distance calculator for calculating a moving distance using the reckoning location input from the location calculator; and
a signal intensity controller for reducing a value of the GPS satellite signal intensity stored in the storage unit when the moving distance is equal to or greater than a second threshold value, and for updating the reduced satellite signal intensity in the storage unit, wherein the reliability includes the satellite signal intensity stored in the storage unit.

14. The mobile terminal of claim 13, wherein the signal intensity controller reduces the value of the GPS satellite signal intensity stored in the storage unit when the reckoned time of a location is equal to or greater than a third threshold value.

15. The mobile terminal of claim 14, wherein the second and third threshold values are set to different values according to speed information input from the sensor unit.

16. The mobile terminal of claim 14, wherein the location calculator calculates speed using GPS satellite information received by the GPS receiving unit, and the second and third threshold values are set to different value according to the calculated speed.

17. The mobile terminal of claim 14, wherein the moving distance calculator calculates a moving distance calculates the moving distance with the reckoning location using map information stored in the storage unit or altitude information input from the sensor unit.

18. The mobile terminal of claim 12, wherein the location calculator stores the GPS satellite information input received by the GPS receiving unit, and the reliability evaluator comprises:
a displacement calculator for calculating a displacement for the reckoned timed of a location; and
a signal intensity controller for comparing the displacement with a fourth threshold value to control satellite signal intensity of the GPS satellite information stored in the storage unit, and updating the controlled satellite signal intensity in the storage unit, wherein the evaluated reliability includes the satellite signal intensity stored in the storage unit.
